(19) United States
(12) Patent Application Publication
(10) Pub. No.: US 2015/0300445 A1
(43) Pub. Date: Oct. 22, 2015

(54) VIBRATION DAMPING DEVICE

(71) Applicant: SUMITOMO RIKO COMPANY LIMITED, Komaki-shi (JP)

(72) Inventors: Junji ABE, Komaki-shi (JP); Takashi HAYASHI, Komaki-shi (JP)

(21) Appl. No.: 14/513,963

(22) Filed: Oct. 14, 2014

(30) Foreign Application Priority Data
Apr. 18, 2014 (JP) 2014-086759

(51) Int. Cl. F16F 15/08; B60K 5/12

(52) U.S. Cl. CPC F16F 15/08; B60K 5/1208

(57) ABSTRACT

A vibration damping device including a first mounting member and a tube-shaped second mounting member elastically connected by a main rubber elastic body, the second mounting member being configured to be fixed by press fitting to an outer bracket. The second mounting member has a small-diameter fixed part at a first axial side thereof, and the fixed part is fixed in an embedded state to the main rubber elastic body so as to be covered by the main rubber elastic body. The fixed part has a surface shape with a corner made dull at an inner circumference edge part of an axial end part thereof. A press-fitting surface of the second mounting member to be fitted to the outer bracket has a larger diameter than that of the main rubber elastic body which covers the fixed part.

### INCORPORATED BY REFERENCE

The disclosure of Japanese Patent Application No. 2014-086759 filed on Apr. 18, 2014 including the specification, drawings and abstract is incorporated herein by reference in its entirety.

### BACKGROUND OF THE INVENTION

1. Field of the Invention

The present invention relates to a vibration damping device used for an engine mount of an automobile or the like, for example.

2. Description of the Related Art

From the past, known are vibration damping devices interposed between members constituting the vibration transmission system, as one type of vibration damping coupling body or vibration damping support body for vibration damping coupling those members to each other, and these are used for the engine mount of an automobile or the like. This vibration damping device, for example as shown in U.S. Publication No. US 2008/0093785, has a constitution for which a first mounting member attached to one member (power unit or the like) constituting the vibration transmission system and a second mounting member attached to the other member (vehicle body or the like) constituting the vibration transmission system are elastically connected by a main rubber elastic body.

However, with the vibration damping device, to realize an improvement in durability of the main rubber elastic body, it is preferable to ensure a large free length of the main rubber elastic body in the coupling direction of the first mounting member and the second mounting member.

However, with the vibration damping device of a constitution for which the second mounting member is press-fit mounted onto an outer bracket, the outer diameter dimension of the second mounting member is set according to the size of the outer bracket, and is limited by the structure of the vehicle body or the like that is subject to mounting with the outer bracket. Also, depending on things such as the press fit direction of the second mounting member to the outer bracket, it is difficult to make the main rubber elastic body project further to the outer circumference side than the press-fitting surface of the second mounting member to be fitted to the outer bracket, so there are cases when it is difficult to ensure a large free length of the main rubber elastic body, and there was the risk of not being able to obtain sufficient durability.

As shown in Japanese Patent No. JP-B-4671176, using a constitution with which a top end part of the second mounting member is embedded in the main rubber elastic body, and the top surface and the outer circumference surface of the second mounting member are covered by the main rubber elastic body, the free length of the main rubber elastic body can be set to be large in relation to the size of the second mounting member.

However, when the axial end part of the second mounting member is embedded and fixed to the main rubber elastic body, the edge of the axial end part of the second mounting member is in contact with the main rubber elastic body, so there was also the risk of a crack occurring in the main rubber elastic body during large vibration input, and thus having a decrease in durability.

### SUMMARY OF THE INVENTION

The present invention was created with the circumstances described above as the background, and the problem it is to solve is to provide a vibration damping device of a novel structure by which a significant increase in durability of the main rubber elastic body is realized with a compact structure.

Following, we will note modes of the present invention created to address these kinds of problems. The structural elements used for each mode noted below can be used in as many combinations as are possible.

A first mode of the present invention provides a vibration damping device including: a first mounting member; a tube-shaped second mounting member configured to be fixed by press fitting to an outer bracket; and a main rubber elastic body elastically connecting the first and second mounting members, wherein the second mounting member has a small-diameter fixed part at a first axial side thereof, and the fixed part is fixed in an embedded state to the main rubber elastic body so as to be covered by the main rubber elastic body, the fixed part embedded in the main rubber elastic body has a surface shape with a corner made dull at an inner circumference edge part of an axial end part thereof, and a press-fitting surface of the second mounting member to be fitted to the outer bracket has a larger diameter than that of the main rubber elastic body which covers the fixed part.

With the vibration damping device having a constitution according to this kind of first mode, the fixed part provided at the first axial side of the second mounting member is fixed in an embedded state to the main rubber elastic body. By so doing, using the surface of the part that covers the fixed part with the main rubber elastic body, it is possible to substantially enlarge the free length of the main rubber elastic body in the coupling direction of the first mounting member and the second mounting member, and to improve the durability of the main rubber elastic body. In fact, since the main rubber elastic body is fixed so as to cover the surface of the second mounting member and the free length is set to be large, it is not necessary to have the second mounting member have a large diameter, and it is possible to realize excellent durability with a compact structure.

Furthermore, the inner circumference edge part of the fixed part has a surface shape with the corner made dull, elastic deformation of the main rubber elastic body is effectively generated up to the part that covers the fixed part, and the surface of the part that covers the fixed part with the main rubber elastic body functions effectively as a free surface. As a result, in the coupling direction of the first mounting member and the second mounting member, the free length of the surface of the main rubber elastic body is effectively extended, improving durability.

Furthermore, with the fixed part embedded in the main rubber elastic body, has a surface shape at the inner circumference edge part of the axial end part thereof, so when vibration is input between the first mounting member and the second mounting member, when deformation or stress is transmitted from the inner circumference part of the main rubber elastic body that greatly elastically deforms to the outer circumference part that covers the fixed part, it is possible to prevent having the main rubber elastic body on that transmission path contact the edge of the fixed part and damaging it.

Also, the press-fitting surface constituting the outer circumference surface of the second mounting member to be fitted to the outer bracket has a larger diameter than the main rubber elastic body that covers the fixed part. By so doing, it is also possible to press fit the second mounting member to the outer bracket from the fixed part side, and possible to correspond to the press-fitting direction of the second mounting member according to the outer bracket structure or the like. In fact, even when the second mounting member is press fit from the fixed part side to the outer bracket, the outer circumference end part of the main rubber elastic body that covers the fixed part does not press against the fixed part by the outer bracket, and an adverse effect on the durability of the main unit rubber body is avoided.

A second mode of the present invention provides the vibration damping device according to the first mode, wherein the fixed part embedded in the main rubber elastic body has an inclined part at the axial end part thereof which extends while being inclined to an outer circumference side going axially outward.

With the second mode, the inner circumference edge part of the axial end part of the fixed part is not only a surface shape with the corner made dull, but is also arranged facing further to the outer circumference side. Thus, during vibration input, even when the inner circumference part of the main rubber elastic body is elastically deformed, the stress of the main rubber elastic body is reduced at the contact part of the axial end part of the fixed part to the inner circumference part, and there is further improvement in durability.

Furthermore, by using a combination of the surface shape of the inner circumference edge part of the axial end part for the fixed part and the inclined shape of the inclined part, the part that covers the fixed part with the main rubber elastic body makes it easy to elastically deform together with the inner circumference part of the main rubber elastic body that elastically connects the first mounting member and the second mounting member, and the length extending effect of the free length is more effectively exhibited.

A third mode of the present invention provides the vibration damping device according to the second mode, wherein the inclined part of the fixed part has a curved part that gradually curves to the outer circumference side going axially outward.

With the third mode, the inner circumference edge part of the axial end part of the fixed part is arranged facing further to the outer circumference side by the curved part, and the stress concentration of the main rubber elastic body is reduced at the contact part of the axial end part of the fixed part to the inner circumference part. Thus, there is a further improvement in durability.

Furthermore, by using a combination of the surface shape of the inner circumference edge part of the axial end part of the fixed part and a curved shape of the curved part, the inner circumference surface of the axial end part of the fixed part has a shape extending at a greater incline than the outer circumference side. By so doing, the part of the main rubber elastic body that covers the fixed part easily deforms together with the inner circumference part of the main rubber elastic body, so the substantial free length of the main rubber elastic body is effectively extended, and the improvement in durability is more advantageously realized.

A fourth mode of the present invention provides the vibration damping device according to the first mode, wherein the axial end part of the fixed part extends linearly in an axial direction.

With the fourth mode, the axial end part of the fixed part extends linearly in the axial direction, so that it is possible to realize an adjustment in spring characteristics such as lower dynamic spring in the axial direction, higher dynamic spring in the axis-perpendicular direction or the like.

A fifth mode of the present invention provides the vibration damping device according to any one of the first through fourth modes, wherein a step part is provided in an axially middle portion of the second mounting member, the small-diameter fixed part is provided at the first axial side in relation to the step part of the second mounting member, and a large-diameter press-fit part having the press-fitting surface is provided at a second axial side in relation to the step part.

With the fifth mode, with the second mounting member formed with a designated axial dimension, it is possible to also set the difference in the diameter dimension of the fixed part and the press-fit part to be large, and possible to suitably set the difference in diameter dimensions of the main rubber elastic body that covers the fixed part and the press-fitting surface that is the outer circumference surface of the press-fit part.

With the present invention, the main rubber elastic body covers the fixed part of the second mounting member, so the free length of the main rubber elastic body is ensured without making the diameter larger for the second mounting member, and durability of the main rubber elastic body is improved. Furthermore, since the fixed part has a surface shape with the corner made dull at the inner circumference edge part of the axial end part thereof, having this become the starting end of a crack of the main rubber elastic body is prevented, further improving durability. Also, the press-fitting surface of the second mounting member to be fitted to the outer bracket has a larger diameter than the main rubber elastic body, so the press-fitting direction to the outer bracket of the second mounting member is not limited, and in fact damage by pressing of the main rubber elastic body against the outer bracket during press fitting is avoided.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a vertical cross section view showing a vibration damping device in the form of an engine mount as a first embodiment of the present invention;

FIG. 2 is a fragmentary enlarged view of a principle part of FIG. 1;

FIG. 3 is a vertical cross section view showing the state with the engine mount of FIG. 1 mounted on an outer bracket; and

FIG. 4 is a vertical cross section view showing an engine mount as a second embodiment of the present invention.

### DETAILED DESCRIPTION OF PREFERRED EMBODIMENTS

Following, we will describe embodiments of the present invention while referring to the drawings.

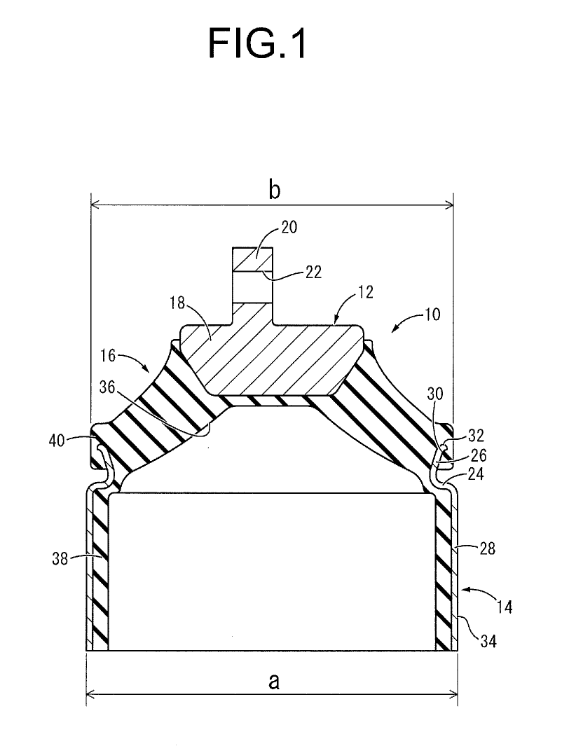

FIG. 1 shows an engine mount 10 for an automobile as a first embodiment of a vibration damping device having the constitution according to the present invention. The engine mount 10 has a constitution with which a first mounting member 12 and a second mounting member 14 are elastically connected by a main rubber elastic body 16. With the description hereafter, the vertical direction, as a general rule, means the vertical direction in FIG. 1 which is the mount center axis direction.

In more detail, the first mounting member 12 is a highly rigid member formed using a metal such as iron or an aluminum alloy or the like, or a fiber-reinforced synthetic resin or the like. Also, the first mounting member 12 is integrally equipped with a main unit 18 having an inverted, roughly truncated cone shape that gradually contracts facing downward, and a plate shaped attachment part 20 that projects upward from the main unit 18. Also, the first mounting member 12 is made to be attached to a power unit (not illustrated) by a bolt or the like that is inserted through a bolt hole 22 of the attachment part 20.

The second mounting member 14 is a member of high rigidity the same as the first mounting member 12, and overall is a thin-walled, large-diameter, roughly round cylinder shape. Also, a step part 24 is provided in the axially middle portion of the second mounting member 14, and a small-diameter fixed part 26 is provided at the first axial side in relation to the step part 24, while a large-diameter press-fit part 28 is provided at the second axial side in relation to the step part 24.

The fixed part 26 has a tapered tube shape that gradually expands going axially outward (upward in FIG. 1), and a curved part 30 is provided on its axial end part that curves so that the change volume of the incline angle toward the outer circumference side becomes gradually greater going axially outward. The fixed part 26 of this embodiment overall is roughly an inclined part that is inclined to the outer circumference side in relation to the axial direction.

Furthermore, with the axial end part of the fixed part 26, the inner circumference edge part has a surface shape with the corner made dull, and an R surface 32 of a roughly arc shaped cross section smoothly continuous with the inner circumference surface of the curved part 30 is set on the inner circumference surface. With this embodiment, the second mounting member 14 is formed by implementing press working on a tubular metal tool, and when press forming the second mounting member 14, the R surface 32 is formed by crushing the inner circumference edge of the fixed part 26 into a designated surface shape. Of course, for example, using a rollover of the inner circumference edge that occurs during press working, after forming the second mounting member 14, by dropping the corner of the inner circumference edge part of the fixed part 26 or the like using post-processing such as cutting or grinding or the like, it is possible to set a designated surface shape for the inner circumference edge part of the fixed part 26.

The inner circumference edge part of the axial end part of the fixed part 26 means the part that connects the inner circumference surface and the axial end surface of the fixed part 26. Also, with this embodiment, the inner circumference edge part of the axial end part of the fixed part 26 is processed so that the R surface 32 having a curved cross section shape which is convex toward the inner circumference side is set. However, it is also possible to process the inner circumference edge part of the axial end part of the fixed part 26 to impart a chamfered surface shape so that one or more plane surfaces continuous with the inner circumference surface of the curved part 30 are set. When setting a plane surface as a substitute for the R surface 32 in this way, a bent line (corner) is formed at the inner circumference surface of the axial end part of the fixed part 26, but by the angle that forms this bent line part being an obtuse angle, improvement in the durability of the main rubber elastic body 16 described later is effectively realized.

The press-fit part 28 has a large-diameter, roughly round cylinder shape extending linearly in the axial direction, and extends out downward from the outer circumference end of the step part 24. Furthermore, the outer circumference surface of the press-fit part 28 is a press-fitting surface 34 that extends in the axial direction at the roughly fixed circular cross section.

Also, the first mounting member 12 is arranged above the second mounting member 14 on roughly the same center axis, and the first mounting member 12 and the second mounting member 14 are elastically connected by the main rubber elastic body 16. The main rubber elastic body 16 is a roughly truncated cone shape, and the small-diameter side end part is adhered by vulcanization to the main unit 18 of the first mounting member 12, and also the large-diameter side end part is adhered by vulcanization to the fixed part 26 of the second mounting member 14. The main rubber elastic body 16 is formed as an integrally vulcanization molded component equipped with the first mounting member 12 and the second mounting member 14.

Furthermore, a large-diameter recess 36 that opens facing downward is formed on the main rubber elastic body 16. This large-diameter recess 36 exhibits an inverted, roughly mortar shape that expands facing downward. Furthermore, a covering rubber 38 projecting facing downward is provided on the outer circumference side of the large-diameter recess 36. The covering rubber 38 is a tube-shaped rubber layer integrally formed with the main rubber elastic body 16, and is fixed to the inner circumference surface of the press-fit part 28 of the second mounting member 14.

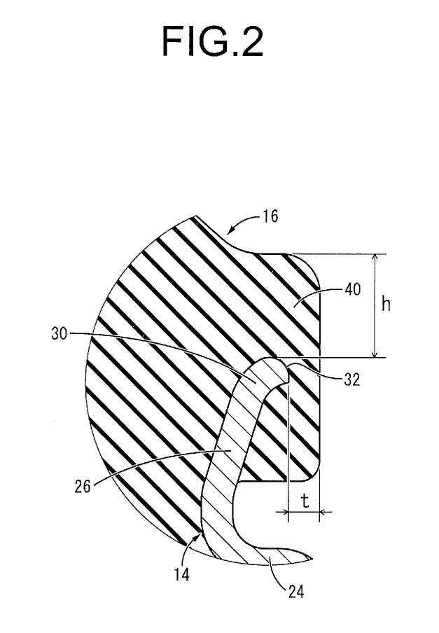

Also, an extension part 40 that covers the top end part of the fixed part 26 is integrally formed on the outer circumference end part of the main rubber elastic body 16. As shown in FIG. 2, the extension part 40 is integrally formed with the main rubber elastic body 16, and is fixed so as to cover the outer circumference side from above the fixed part 26. By so doing, the axial end part of the fixed part 26 is embedded in the main rubber elastic body 16 including the extension part 40, and is covered by the main rubber elastic body 16.

Furthermore, the outer circumference part of the extension part 40 is held further to the inner circumference side than the outer circumference surface of the press-fit part 28 of the second mounting member 14, and the outer diameter dimension (a) of the press-fit part 28 is greater than the outer diameter dimension (b) of the main rubber elastic body 16 including the extension part 40.

The height (h) of the part covering the top surface of the fixed part 26 with the extension part 40 and the thickness (t) of the part covering the outer circumference surface of the fixed part 26 can respectively be set as appropriate according to the size, shape and the like of the second mounting member 14, but it is preferable for both to be set to be sufficiently large. By so doing, the part that covers the top surface of the fixed part 26 and the outer circumference surface with the extension part 40 are not restricted excessively by the fixed part 26, and in a state with sufficient elastic deformation allowed in at least the area across a designated thickness from the surface, this is adhered by vulcanization to the fixed part 26. With the extension part 40 of this embodiment, the height (h) of the part that covers the top surface of the fixed part 26 is greater than the thickness (t) of the part that covers the outer circumference surface.

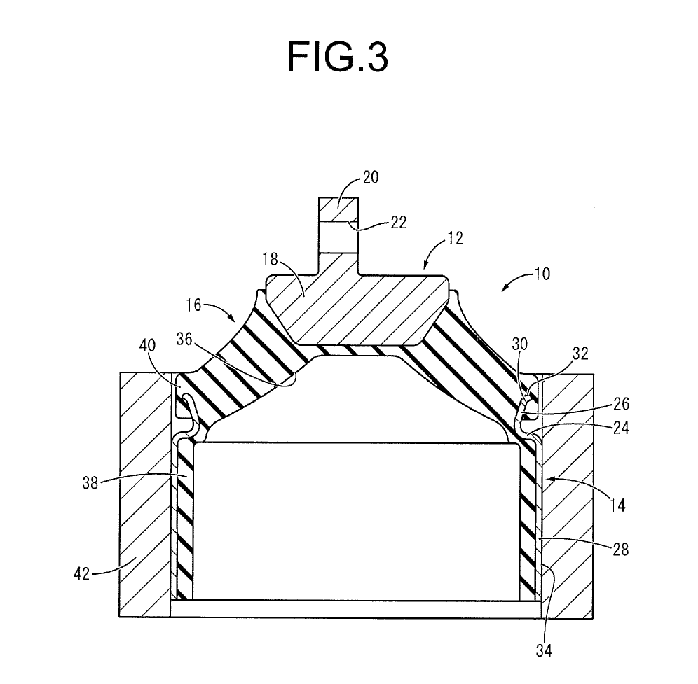

As shown in FIG. 3, an outer bracket 42 is attached to the engine mount 10 constituted as noted above. Specifically, by the press-fit part 28 of the second mounting member 14 constituting the engine mount 10 being press fit in the axial direction to the tube-shaped outer bracket 42, the outer bracket 42 is externally fit and fixed to the press-fitting surface 34 of the second mounting member 14. Then, by the outer bracket 42 being fixed to the vehicle body side (not illustrated), the second mounting member 14 is made to be attached to the vehicle body side.

The diameter dimension (a) of the press-fitting surface 34 with the press-fit part 28 is greater than the external diameter dimension (b) of the main rubber elastic body 16, making it possible to fit the engine mount 10 from the first mounting member 12 side to the outer bracket 42.

Furthermore, in a state with the press-fit part 28 press fit and fixed to the outer bracket 42, the outer bracket 42 extends up to the outer circumference side of the extension part 40 of the main rubber elastic body 16, and the outer circumference surface of the main rubber elastic body 16 is separated from and faces opposite the inner circumference in relation to the inner circumference surface of the outer bracket 42. By so doing, having unnecessary pre-compression applied to the extension part 40 of the main rubber elastic body 16 by the outer bracket 42 is prevented, which improves durability, and also the extension part 40 of the main rubber elastic body 16 protects the outer circumference side at the outer bracket 42, preventing damage of the extension part 40 by contact with flying stones or the like, and degradation due to heat of the extension part 40 or the like. Furthermore, as described later, it is possible to effectively extend the free length of the main rubber elastic body 16 without the extension part 40 of the main rubber elastic body 16 being restricted by the outer bracket 42.

Also, with the engine mount 10 using the constitution according to this embodiment, the main rubber elastic body 16 is equipped with the extension part 40 that covers the fixed part 26 of the second mounting member 14. By so doing, even with a constitution for which the outer diameter dimension (b) of the main rubber elastic body 16 is restricted to being smaller than the outer diameter dimension (a) of the press-fit part 28, it is possible for the free length of the surface of the main rubber elastic body 16 to be effectively extended, and to realize improvements in the durability of the main rubber elastic body 16. In addition, it is possible to efficiently extend the free length of the main rubber elastic body 16 without increasing the diameter of the second mounting member 14, so sufficient durability is ensured using a compact constitution.

In fact, with the axial end part of the fixed part 26 embedded in the extension part 40, the inner circumference edge part has a surface shape with the corner made dull, and the R surface 32 is set on the inner circumference surface. By so doing, with the main rubber elastic body 16, transmission of stress or deformation to the extension part 40 from the inner circumference part that connects the first mounting member 12 and the second mounting member 14 is made to be generated without obstruction by the edge of the inner circumference edge part of the fixed part 26, making it easy to induce elastic deformation of the extension part 40 integrally with the inner circumference part. Accordingly, the free length of the surface of the main rubber elastic body 16 is effectively extended by the extension part 40, and there is an improvement in durability by ensuring a large free length.

In particular with this embodiment, the fixed part 26 has an inclined shape that expands in diameter facing axially outward, and the curved part 30 is provided at the axial end part of the fixed part 26, and the incline angle gradually increases facing axially outward. By so doing, stress and deformation are transmitted more smoothly from the inner circumference part of the main rubber elastic body 16 to the extension part 40, and elastic deformation of the extension part 40 integrally with the inner circumference part is allowed, so it is possible to more advantageously obtain the effect of improving durability by extension of the free length.

In addition, by having the inner circumference surface of the curved part 30 and the R surface 32 be formed smoothly and continuously, it is easy to allow elastic deformation of the extension part 40 integrally with the inner circumference part at the main rubber elastic body 16, and to more advantageously ensure durability.

Furthermore, with this embodiment, the extension part 40 is formed having sufficient thickness dimensions respectively on the axially outside and on the outer circumference side of the fixed part 26. By so doing, elastic deformation of the extension part 40 is effectively allowed without having the extension part 40 excessively restricted by the fixed part 26. Therefore, even when the fixed part 26 has a small diameter, the free length of the main rubber elastic body 16 is effectively extended by the extension part 40, realizing an improvement in durability.

Also, by having the R surface 32 set on the inner circumference surface of the axial end part of the fixed part 26, the inner circumference part of the main rubber elastic body 16 and the extension part 40 covering the fixed part 26 are integrally deformed in an elastic manner, and when the extension part 40 presses against the fixed part 26, the extension part 40 pushes against the curved surface shape R surface 32. As a result, the stress at the abutting part of the fixed part 26 with the extension part 40 is dispersed, so it is difficult for the inner circumference edge of the axial end part of the fixed part 26 to be the starting end of a crack or the like, so even with the constitution that actively allows elastic deformation of the extension part 40 that covers the fixed part 26, the durability of the main rubber elastic body 16 is ensured.

In particular with this embodiment, since the R surface 32 is provided to be smoothly continuous with the inner circumference surface of the curved part 30, when stress is transmitted from the inner circumference part of the main rubber elastic body 16 to the extension part 40, the inner circumference surface of the fixed part 26 that is adhered to the part of the extension part 40 that is elastically deformed easily is given a shape that is smoothly continuous across the entirety, so dispersion of the stress applied to the extension part 40 is more effectively realized, further improving durability.

Furthermore, with this embodiment, the R surface 32 of the inner circumference edge part of the fixed part 26 is formed simultaneously with press working of the second mounting member 14, so it is possible to easily manufacture the second mounting member 14 with few manufacturing steps without requiring special post-processing.

Also, the fixed part 26 has an inclined shape that expands facing axially outward, and the axial end part of the fixed part 26 extends facing the outer circumference side. Therefore, the inner circumference edge part of the axial end part of the fixed part 26 is arranged facing the outer circumference side avoiding the inner circumference part of the main rubber elastic body 16 that easily deforms during vibration input, improving durability. In fact, it is easier for the main rubber elastic body 16 to be compressed between the first mounting member 12 and the fixed part 26 in relation to vertical direction input, realizing higher dynamic spring in the axial direction.

Furthermore, the curved part 30 is provided at the top end part of the fixed part 26, and the top end part of the fixed part 26 extends curving to the outer circumference side. By so doing, the inner circumference part that easily elastically deforms with the main rubber elastic body 16 is adhered to the smooth inner circumference surface of the curved part 30, and the axial end of the fixed part 26 is arranged facing the outer circumference side, and the axial end part of the fixed part 26 is adhered to the outer circumference part of the extension part 40 that has a relatively small elastic deformation volume. As a result, it is possible to further improve the durability of the main rubber elastic body 16.

Also, with this embodiment, the step part 24 is formed in the axially middle portion of the second mounting member 14, and the small-diameter fixed part 26 and the large-diameter press-fit part 28 are formed at both sides sandwiching the step part 24. By so doing, it is possible to make the outer diameter dimensions of the fixed part 26 and the press-fit part 28 significantly different without making the axial dimension of the second mounting member 14 larger, and it is easy to set the outer diameter dimension of the press-fit part 28 to be larger than the outer diameter dimension of the main rubber elastic body 16 that is adhered by vulcanization to the fixed part 26.

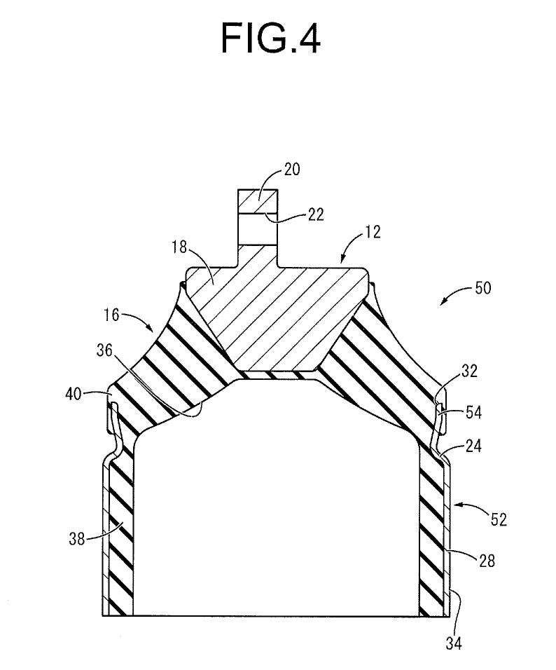

FIG. 4 shows an engine mount 50 of a vehicle as a second embodiment of the vibration damping device of the present invention. The engine mount 50 has a constitution for which the first mounting member 12 and a second mounting member 52 are elastically connected by the main rubber elastic body 16. With the description hereafter, for substantially the same members and parts as those of the first embodiment, the same code number is given in the drawings, and a description will be omitted.

The second mounting member 52 has a thin-walled, large-diameter, roughly round cylinder shape, and sandwiching the step part 24 provided in the axially middle portion, the first side serves as a small-diameter fixed part 54, and the second side serves as the large-diameter press-fit part 28.

The fixed part 54 has a tube shape that projects upward from the inner circumference end of the step part 24, and the axially inside part (lower part) has a tapered tube shape that expands gradually facing axially outward, and the end part (top part) on the axially outside has a cylinder shape that extends linearly in a roughly fixed cross section shape in the axial direction. The outer circumference surface of the fixed part 54 is positioned to the inner circumference side in relation to the outer circumference surface of the press-fit part 28.

Also, the fixed part 54 is embedded and fixed to the main rubber elastic body 16 containing the extension part 40, and is covered by the main rubber elastic body 16. Here, the same kind of R surface 32 as of the first embodiment is formed on the top end inner circumference edge part of the fixed part 54.

Even with the engine mount 50 constituted according to this kind of embodiment, the same as with the first embodiment, the free length of the main rubber elastic body 16 is ensured to be large, and with the fixed part 54 embedded and attached to the main rubber elastic body 16, by having the axial end part of the inner circumference surface be the R surface 32 or the like, the durability of the main rubber elastic body 16 is improved.

In fact, with the engine mount 50, since the axial end part of the fixed part 54 is a tube shape extending in the axial direction with a roughly fixed cross section shape, compared to the first embodiment, during vibration input in the axial direction, the sheer spring component of the main rubber elastic body 16 is dominant. As a result, it is possible to have lower dynamic spring in the axial direction, and to easily set vibration damping characteristics that are different from those of the engine mount 10 of the first embodiment.

Above, we gave a detailed explanation of embodiments of the present invention, but the present invention is not limited to those specific descriptions. For example, the specific constitution of the first mounting member is merely an example, and is not specifically restricted. Also, the second mounting member does not necessarily have to be an overall tube shape, and it is also possible to use a constitution for which a tube-shaped part is provided for a portion of the second mounting member.

It is also possible to not have the step part between the fixed part and the press-fit part with the second mounting member, and for example it is possible to have between the fixed part and the press-fit part with the second mounting member be a tapered shape that gradually contracts facing the fixed part side. Furthermore, the fixed part can also extend linearly in the axial direction with a roughly fixed cross section shape.

Furthermore, for the upper end outer circumference part of the fixed part, the same as the inner circumference edge part, the surface shape such as the R surface 32 can be set as necessary.

The present invention can also be suitably applied to fluid-filled vibration damping devices equipped with a fluid chamber in which non-compressible fluid is sealed therein (e.g. US 2008/0093785 or the like).

The application scope of the present invention is not limited to a vibration damping device used as an engine mount, but for example also can include a vibration damping device used for a sub-frame mount, body mount, differential mount or the like. Furthermore, the present invention can be applied not only to the vibration damping device of an automobile, but also to the vibration damping device used for example with a motorcycle, a railroad vehicle, an industrial vehicle or the like.

What is claimed is:

1. A vibration damping device comprising:
a first mounting member;
a tube-shaped second mounting member configured to be fixed by press fitting to an outer bracket; and
a main rubber elastic body elastically connecting the first and second mounting members, wherein
the second mounting member has a small-diameter fixed part at a first axial side thereof, and the fixed part is fixed in an embedded state to the main rubber elastic body so as to be covered by the main rubber elastic body,
the fixed part embedded in the main rubber elastic body has a surface shape with a corner made dull at an inner circumference edge part of an axial end part thereof, and
a press-fitting surface of the second mounting member to be fitted to the outer bracket has a larger diameter than that of the main rubber elastic body which covers the fixed part.

2. The vibration damping device according to claim 1, wherein the fixed part embedded in the main rubber elastic body has an inclined part at the axial end part thereof which extends while being inclined to an outer circumference side going axially outward.

3. The vibration damping device according to claim 2, wherein the inclined part of the fixed part has a curved part that gradually curves to the outer circumference side going axially outward.

4. The vibration damping device according to claim 1, wherein the axial end part of the fixed part extends linearly in an axial direction.

5. The vibration damping device according to claim 1, wherein
a step part is provided in an axially middle portion of the second mounting member,
the small-diameter fixed part is provided at the first axial side in relation to the step part of the second mounting member, and
a large-diameter press-fit part having the press-fitting surface is provided at a second axial side in relation to the step part.
